(19) United States
(12) Patent Application Publication
(10) Pub. No.: US 2018/0268746 A1
(43) Pub. Date: Sep. 20, 2018

(54) DOCUMENT COVER FOR MOTOR VEHICLE AFFIXMENT

(71) Applicants: John T. De Vallee, Lewisville, TX (US); Heather C. Vale, Frisco, TX (US); Peter Vale, Frisco, TX (US)

(72) Inventors: John T. De Vallee, Lewisville, TX (US); Heather C. Vale, Frisco, TX (US); Peter Vale, Frisco, TX (US)

(21) Appl. No.: 15/762,051

(22) PCT Filed: Sep. 19, 2016
(86) PCT No.: PCT/US2016/052411

§ 371 Date: Mar. 21, 2018

Related U.S. Application Data
(60) Provisional application No. 62/241,023, filed on Oct. 13, 2015.

(51) Int. Cl. G09F 7/12; G09F 3/20; G09F 3/10; G09F 21/04

(52) U.S. Cl. CPC G09F 7/12; G09F 21/04; G09F 3/10; G09F 3/203

(57) ABSTRACT

A weatherproof document cover apparatus used to affix MSRP, Addendum Sheets and/or other documents and secure the same to a glass surface of a motor vehicle which can be used as a protective cover to preprinted documents, a printable cover which can be applied to a motor vehicle window, or an integrated device which incorporates embedded circuitry components while conforming to regulations requiring information disclosure through the process of displaying documents to windows or other glass surfaces.

### CROSS-REFERENCE TO RELATED APPLICATION

### Article 8 Claiming Priority

Priority is claimed from U.S. provisional application for patent 62/241,023 filed on Oct. 13, 2015, and U.S. Non-provisional application Ser. No. 15/206,479 later filed on Jul. 11, 2016 which are hereby incorporated by reference. This application may be related to the present application, or may have some drawings and/or disclosure in common.

### FIELD OF INVENTION

The present invention relates in general to the display of documents on motor vehicles, and in particular, to a document cover for covering manufacturer's pricing sheets and dealer pricing addendums sheets which are mounted to motor vehicle to comply with federal, state and local regulations.

### BACKGROUND OF INVENTION

Various regulations and practices around the world, including US federal, state and local regulations require that motor vehicles being offered for sale display disclosure information in a conspicuous manner. Some regulations, by way of illustration, but not limitation, require the display of two sheets listing sales price information. In the US, the first sheet is a manufacturer's suggested retail price (“MSRP Sheet”) also known as a Monroney. The second is a pricing addendum (“Addendum Sheet”) added by the retailer, or by the dealer, if there are dealer add-ons. Other documents may also be required either now, or in the future. Here, the present embodiment will be illustrated as applied under US regulations with the intent to not limit the application of the present embodiment to only US markets or its regulations exclusively.

US Federal regulations require that the MSRP Sheet and the Addendum Sheet are securely affixed to the vehicle prior to sale. Other countries have regulations, practices and protocols which carry similar obligations as those in the US. Prior art MSRP Sheets and Addendum Sheets have typically been placed on the inside of the windows to protect them from the elements.

The MSRP Sheets and the Addendum Sheets placed on the exterior side of a window in an exposed condition will likely not withstand weather elements and will quickly deteriorate and wear off. Also, the washing of cars speeds the deterioration when the sheets are placed on the exterior of the windows for motor vehicles.

When the MSRP Sheet and Addendum Sheet are adhesively secured directly onto windows, a tacky residue will be left when the MSRP Sheets and Addendum Sheets are removed. When removing such sheets, buyer prep crews for automobile dealerships typically have to scrape the adhesive residue from the window, which is much more difficult from the inside surfaces of windows than if placed on exterior surfaces. Also, if the interior side of the window has window tint film applied, affixing the documents to the inside of the window may be precluded to avoid causing damage to the window tint film when removing the documents at a later time. Improvements are desired.

The present embodiment introduces a practical solution to affixing documents or other advertisements to a window which is cost effective to apply and remove, is resilient to exposures typically found in an automotive dealership display environment, and which provides additional technological functions.

In the present embodiment, the document cover presented herein provides the user the option to present the documents by either affixing the apparatus described herein to the interior or exterior side of a window. Furthermore, the document cover itself is configured to specifically accept the size and dimension of the industry standard documents, commonly known as the Addendum and Monroney (or MSRP) sheets or stickers, such that the integrated document cover, containing alignment reference marks for positioning documents, provides for aesthetically pleasing and professionally appearing positioning and display of required information. Additional sizes can be defined for various documents for which the cover is to protect.

Considering that a typical automobile dealer desires to comply with all legal notice displays, the dealer must display these documents on an automobile which has a sales price in excess of tens of thousands of dollars. Accordingly, the display of notices requires a clean installation which informs while not distracting the consumer during the sales process.

As mentioned above, displaying of documents is a legal requirement and the act of displaying the documents adds nothing to the price or profit a dealer might expect when selling a vehicle. However, the time and effort to affix and remove the documents is a cost the dealer must absorb, along with any resulting damage to the vehicle which might occur during the affixing or removal of the documents. Therefore, improvements are desired.

The present embodiment is designed to ensure proper alignment of paper documents, provides protection from wear and tear, improves efficiency in the initial application and subsequent removal process, and extends the longevity of documents being displayed which eliminates removal and replacement when a vehicle is displayed for extended periods of time.

Additionally, technology integrated solutions are advantageous to both the dealer and the consumer. The present embodiment anticipates the need for the document cover contemplated herein to accommodate additional technological features which include: a direct print document cover where the image of the MSRP and Addendum are printed directly onto the document cover material which is applied to the window as a single integrated document; RF identification tags positioned between the document cover, document and glass surface; RF identification chips and antenna layered into the fabrication of the plastic film used to construct the document cover; or, magnetic properties incorporated with the ink, adhesive, or tint film layer of the plastic cover. These are but a few illustrations of how technology can be incorporated to enhance the dealer's ability to track, scan or capture information during the sales display process. These are also but a few illustrations of how technology can aid the consumer in using smart phones and other electronic means to explore online information about the dealer, manufacturer or particular model being considered.

Although there are several apparatuses which may have various functions related to document cover for motor vehicle affixments, none separately or in combination, teach or anticipate the current invention. Therefore, there remains an unmet need in the field of document covers to enable users to affix documents to windows which are resilient to weather, exposure to elements and impacts resulting from car washing, window cleaning, touching and other reasonable exposures an object may encounter when on display to the public; and, which utilize technology to enhance the sales process. The current invention will fulfill this unmet need.

### SUMMARY OF INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

An apparatus and method of use for document display provides a document cover for securing documents, such as the MSRP Sheet and Addendum Sheet, to windows of motor vehicles offered for sale.

Regarding the apparatus, the document cover is a plastic document cover; which, can accept application of either paper documents; or in the alternative, direct application of ink as a printable surface, which serves as a base layer defined by a sheet of plastic material having a tacky surface and an exterior side, which face in opposite directions providing tamper resistant, weather resistant and fading resistant protections to documents or printed material. This document cover is applied to documents or printed material which are to be displayed on windows in compliance with regulatory requirements of information disclosures.

The document cover is designed to be durable and suitable for continuous use and exposure to friction, weather, direct sunlight and stresses associated with windows; and, to be easily removable after the duration of time which the information disclosure is required. The document cover with integrated technology as envisioned, can also function as an interactive display; which, by way of illustration, represents an electronic document cover which can retrieve and display information from databases utilizing wireless networking, accommodate time and date criteria to control promotional adjustments to content being displayed, and maintain document version control and archival processes to store document history with enhanced version control recorded by GPS location in additional to date and time.

The apparatus has dimensions specific to industry requirements for information disclosures so as to result in a professional and aesthetically pleasing display on the vehicle; and, the document cover has predefined sectional areas confined within the total surface area which can be printed or have multiple documents individually applied to the tacky surface of the document cover, at different times, while maintaining the integrity of the document cover and the utility of the document cover when applied to a glass surface.

The document cover can also integrate with embedded circuitry components capable of visual, optical, radio frequency, magnetic or chemical response to external stimuli or observation; and, embedded circuitry components capable of stimuli response suitable for use in proximity determination, access control, inventory control, time duration or visual cues.

Regarding the method of use, the document cover is first preferably laid on a flat surface with a tacky surface up. The MSRP Sheet and the Addendum Sheet are then laid face-down on the tacky surface of the document cover, with a border provided by the document cover preferably extending fully around each of the MSRP Sheet and the Addendum Sheet and a center space disposed between the MSRP Sheet and the Addendum Sheet. The MSRP Sheet and the Addendum Sheet are then each pressed against the document cover to adhesively secure the MSRP Sheet and the Addendum Sheet to the tacky surface of the document cover, preferably by working from the inside of each sheet outward with a squeegee, hard card, or other application tool.

Then the document cover is picked up, with the MSRP Sheet and Addendum Sheet secured to the document cover, and the document cover is aligned for display and placed against the glass surface of a window of the vehicle, typically provided by either a windshield or a side window. The center space provides a midpoint for keeping the MSRP Sheet and the Addendum Sheet off the glass surface of the windshield or window, as the center spaced is pressed against the glass surface.

The center space is preferably pressed against the glass surface by working the inside outward, that is, working upward and downward to adhesively secure the center space to the glass surface. The wider sheet, typically the MSRP Sheet, is then worked to press the border space of the document cover adjacent to the MSRP Sheet against the glass surface, working from the midpoint of the center space outward to the exterior of the document disposed between the MSRP Sheet and edge of the document cover. Then, the narrower sheet, typically the Addendum Sheet, is worked to press the border space of the document cover adjacent to the Addendum Sheet against the glass surface, working from the fold line of the center space outward to the exterior of the document disposed between the Addendum Sheet and the peripheral edge of the document cover.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a broadside elevation view of a document display having a document cover, a MSRP Sheet and an Addendum Sheet;

FIG. 2 is an edge view of the document display showing the MSRP Sheet and the price Addendum Sheet secured to the inward, adhesive side of the document cover;

FIG. 3 is an edge view of the document display secured to the surface of a glass window of a motor vehicle; and,

FIGS. 4A and 4B together define a flow chart describing a method of securing a document display of an MSRP Sheet and an Addendum Sheet to a glass window of a motor vehicle.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION

The claimed subject matter is now described with reference to the drawings. In the following description, for purposes of explanation, numerous specific details are set forth in order to provide a thorough understanding of the claimed subject matter. It may be evident; however, that the claimed subject matter may be practiced with or without any combination of these specific details, without departing from the spirit and scope of this invention and the claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be routine undertaking for those of ordinary skill in the art having the benefit of this disclosure.

The apparatus and method of use in accordance with the present application overcomes one or more of the above-discussed problems commonly associated affixing documents to windows. Specifically, the apparatus and method of use of the present embodiment provides rapid and effective means to deploy legal notice documents, disclosures, advertisements and other documents under applicable situations discussed above. These and other unique features of the apparatus and method of use are discussed below and illustrated in the accompanying drawings.

The apparatus and method of use will be understood, both as to its structure, configuration and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Referring now to the drawings wherein like reference characters identify corresponding or similar elements throughout the several views, the apparatus and method of use are illustrated.

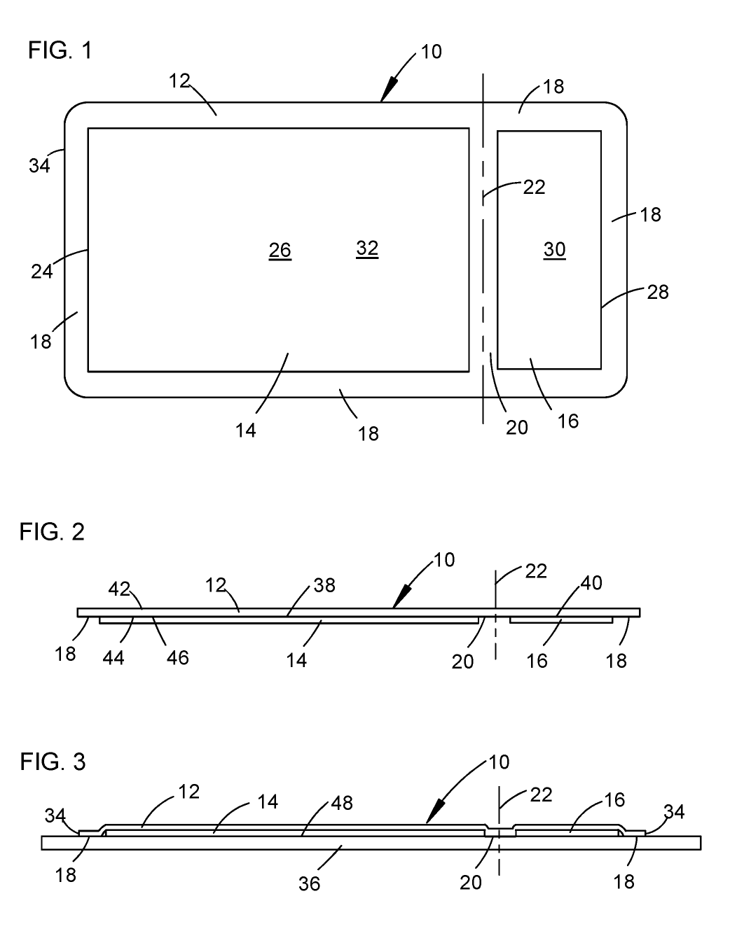

FIG. 1 is a broadside elevation view of a document display 10 for mounting to a glass surface of a window for a motor vehicle. Typically, the window will be either a side window or a windshield. The document display 10 has a document cover 12 extending across the entire surface preferably defined by a sheet of plastic having an exterior side 42, FIG. 2 which is a smooth surface and an interior side 44, FIG. 2 which provides a tacky surface 46, FIG. 2. The document cover has a center portion 32 and a peripheral edge 34 which is defined to extend entirely around the document underneath the document cover 12.

The document cover 12 can accept direct application of ink as a printable surface, which serves as a base layer in lieu of affixing a printed paper documents such as a manufacturers sales retail pricing sheet (“MSRP Sheet”) 14 and an automobile dealer's price addendum sheet (“Addendum Sheet”) 16 to the document cover 12.

Additionally, the document display 10 which has border space 18 and center space 20 which are suitable for embedded circuitry components capable of visual, optical, radio frequency, magnetic or chemical response to external stimuli or observation. Such stimuli response is suitable for use in proximity determination, access control, inventory control, time duration or visual cues. External database networking functionality and, version control with archiving functionality is enabled by embedding antenna within the border space 18 or center space 20. Alternatively, such electronic devices may be layered between the MSRP Sheet 14 or the Addendum Sheet 16 when these documents are applied to the document cover 12.

The document display 10 has dimensions specific to industry requirements for information disclosures so as to result in a professional and aesthetically pleasing display on the vehicle; and, the document cover 12 has predefined sectional areas confined within the total surface area which can have multiple documents individually applied to the tacky surface of the document cover 12, at different times, while maintaining the integrity of the document cover 12 and the utility of the document display 10 when applied to a glass surface.

The document cover 12 can also integrate with embedded circuitry components capable of visual, optical, radio frequency, magnetic or chemical response to external stimuli or observation; and, embedded circuitry components capable of stimuli response suitable for use in proximity determination, access control, inventory control, time duration or visual cues.

The MSRP Sheet 14 and Addendum Sheet 16 are adhesively secured to the interior side 44 of the document cover 12 by means of an adhesive coating. The document cover 12, the MSRP Sheet 14 and the Addendum Sheet 16 are configured to define a border space 18 of the document cover 12 which preferably extends entirely around the MSRP Sheet 14 and the Addendum Sheet 16, adjacent to a peripheral edge 34 of the document cover 12. The border space 18 preferably extends adjacent to the entire peripheral edge 34 of the document cover 12, and is preferably at least one-half inch wide.

The MSRP Sheet 14 and the Addendum Sheet 16 are preferably spaced apart by at least one-half inch to define a center space 20 which extends between a peripheral edge 24 of the MSRP Sheet 14 and a peripheral edge 28 of the Addendum Sheet 16. A midpoint 22 is preferably provided by a vertical line which extends centrally between the peripheral edge 24 of the MSRP Sheet 14 and the peripheral edge 28 of the Addendum Sheet 16 in the center space 20. The midpoint 22 can be offset to accommodate other document dimensions as desired. Centrally disposed within the peripheral edge 24 of the MSRP Sheet 14 is a center portion 26 of the MSRP Sheet 14. Similarly, centrally disposed with the peripheral edge 28 of the Addendum Sheet 16 is a central portion 30 of the Addendum Sheet 14.

FIG. 2 is an edge view of the document display 10 showing the MSRP Sheet 14 and the Addendum Sheet 16 secured to the document cover 12 by an adhesive coating of the tacky surface 46 of the interior side 44. The adhesive coating is disposed on the interior side 44 and preferably extends across the entire interior side 44 to define a tacky surface 46 for the document cover 12.

The MSRP Sheet 14 and the Addendum Sheet 16 each have respective faces 38 and 40, which are the front portions on which the readable text is displayed to convey the pricing information for each. The faces 38 and 40 are pressed directly against the interior side 44 of the document cover 12 to secure the MSRP Sheet 14 and the Addendum Sheet 16 to the document cover 12. In the preferred embodiment, the MSRP Sheet 14 and the Addendum Sheet 16 are made of paper and are permanently secured to the document cover 12.

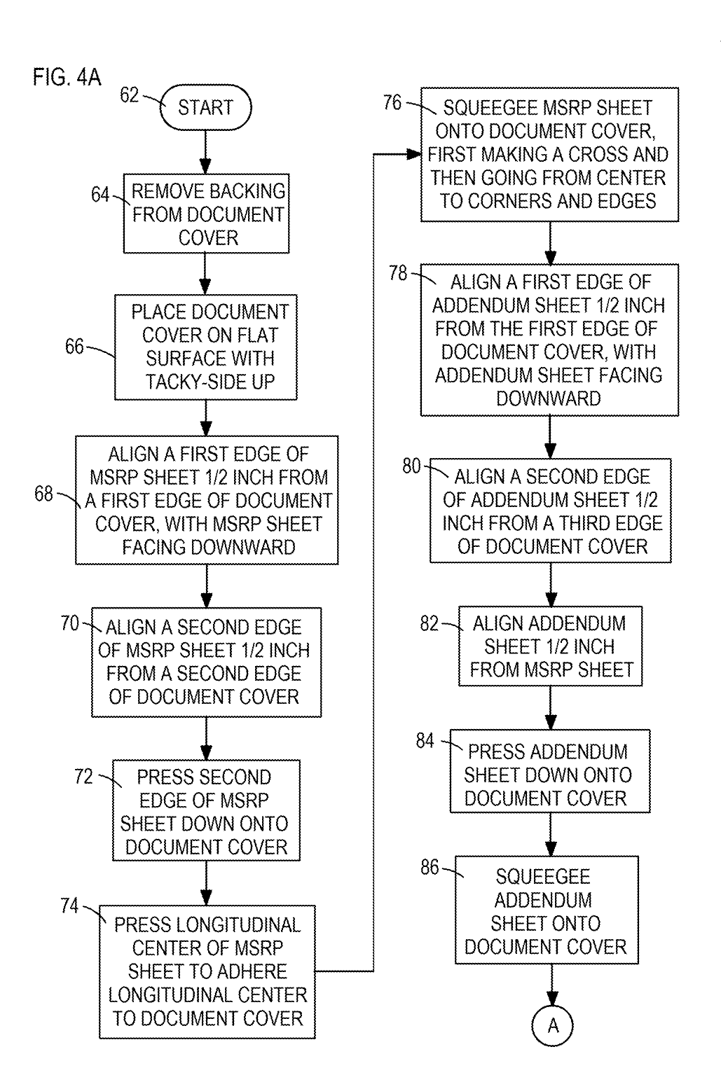

FIG. 3 is an edge view of the document display 10 after it is secured to the surface of a glass window 36 of a motor vehicle. The glass window 36 may be provided by a windshield, side window or other clear glass surface of the motor vehicle. The adhesive on the interior side 44 of the document cover 12 located along the border space 18 and the center space 20 will secure the document cover 12 with the MSRP Sheet 14 and the Addendum Sheet 16 to the surface of the glass window 36 of a motor vehicle windshield or a side window.

As noted above, the border space 18 preferably extends entirely around the MSRP Sheet 14 and the Addendum Sheet 16, adjacent to the entire peripheral edge 34 of the document cover 12, and the center space 20 is disposed between the MSRP Sheet 14 and the Addendum Sheet 16.

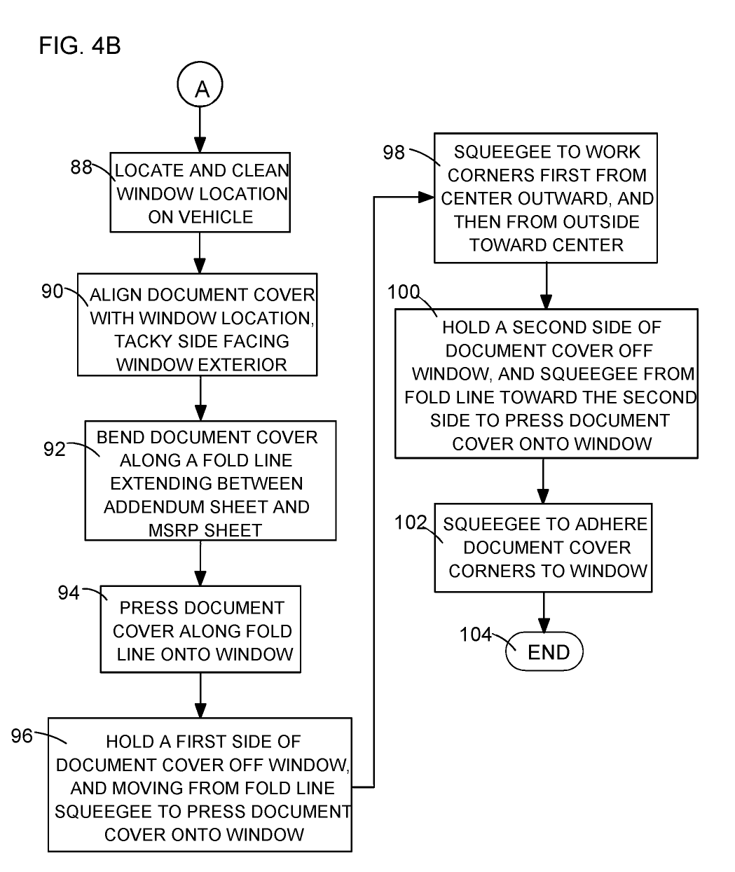

FIGS. 4A and 4B together comprise a flow chart showing a method for affixing a document display 10 to the exterior surface of a glass window 36 of a motor vehicle. The document display 10 provides an affixment to the motor vehicle, and includes the document cover 12 with the MSRP Sheet 14 and the Addendum Sheet 16.

The process starts at step 62. Then in step 64 a protective backing is removed from the tacky surface 46 on the interior side 44 of the document cover 12. In step 66 the document cover 12 is then placed on a flat surface with the adhesive or tacky surface 46 facing upward. In step 68 the top and bottom edges of the MSRP Sheet 14 are aligned approximately one-half inch from the upper and lower peripheral edge 34 of the document cover 12, with face 38 of the MSRP Sheet 14 facing downward.

In step 70 the right peripheral edge 24 of the MSRP Sheet 14 is disposed approximately one-half inch from the right peripheral edge 34 of the document cover 12, as viewed when looking toward the interior surface 44 of the document cover 12 and the backside surface, opposite the face 38, of the MSRP Sheet 14.

Once the MSRP Sheet 14 is aligned with the document cover 12, then in step 72 a central portion of the right side of the peripheral edge 24 of the MSRP Sheet 14 is pressed downward and onto the tacky surface 46 of the interior side 44 of the document cover 12, adhesively securing the central portion to the document cover 12. In step 74 a longitudinally extending centerline of the MSRP Sheet 14 which extends through the central portion 26 is pressed downward onto the tacky surface 46 of the interior side 44 of the document cover 12 to adhere the centerline to a central section of the document cover step 74.

In step 76 the entire MSRP Sheet is pressed onto the tacky surface 46 of the interior side of the document cover 12 using a squeegee and pressing first in cross pattern with a vertical line and a horizontal line intersecting in the central portion 26 of the MSRP Sheet 14, and then pressing with the squeegee from the central portion 26 to the respective edges on the four corners of the MSRP Sheet 14, to adhesively secure the MSRP Sheet 14 to the interior side 44 of the document cover 12.

In step 78, with the Addendum Sheet 16 facing downward, the top and bottom edges of the Addendum Sheet 16 are aligned one-half inch from upper and lower edges of document cover 12. In step 80 the left edge of the Addendum Sheet 16 is aligned one-half inch from left edge of document cover 12, with the face 38 of the Addendum Sheet 16 facing downward toward the interior surface 44 of the document cover 12 and to the side of the MSRP Sheet 14. In step 82 the right side of a backside of the peripheral edge 28 of Addendum Sheet 14 is aligned one-half inch from the left side of the backside of the peripheral edge 24 of the MSRP Sheet 12.

In step 84 the center of the Addendum Sheet is pressed downward on the tacky surface 46 of the document cover 12. In step 86 the entire Addendum Sheet is pressed onto the tacky surface 46 of the interior side of the document cover 12 using a squeegee and pressing on the central portion 30 to the top of the Addendum Sheet 16 and then from the central portion 30 to the bottom of the Addendum Sheet 16, adhesively securing the Addendum Sheet 16 to the interior side 44 of the document cover 12.

After the MSRP Sheet 14 and the Addendum Sheet 16 have been secured to the document cover 12 by the adhesive on the interior side 44, it is ready for installation onto a surface location 48 on the glass window 36 of a motor vehicle. In step 88 the surface location 48 of the glass window 36 is located and then cleaned. In step 90 the document cover 12 is aligned with exterior surface location 48, with the exposed portions of the tacky surface 46 of the interior side 44 of the document cover facing the surface location 48.

The exposed portions of the interior side 44 of the document cover 12 preferably comprise those portions not covered by the MSRP Sheet 14 and the Addendum Sheet 16, namely the center space 20 and the border space 18 which extends adjacent to the peripheral edge 34 of the document cover 12. Then in step 92 the document display 10 is bent along the midpoint 22 between the MSRP Sheet 14 and the Addendum Sheet 16. In step 94 the document cover 12 is pressed along the fold line 22 onto the exterior of the surface location 48 of the glass window 36, which secures the exposed tacky surface 46 of the center space 20 to the glass window 36.

In step 94 the center space 20 is pressed by starting at a central portion, and then pressing from the center portion to the top of the center space 20 and then from the central portion to the bottom of the center space 20.

Then in step 96 the exposed surfaces of the left side of the document cover 12 are secured to the glass window 36 by holding the left side off the glass window 36, and pressing downward with the squeegee moving from the midpoint 22 across a central portion 26 of the face 38 of the MSRP Sheet 14, which is underneath the document cover 12, and pressing downward with the squeegee or other installation device by alternate pressing from the central portion 26 to the top and then the bottom of the document cover 12 while moving across the left side of the document cover 12, from the fold line 22 to the left side of the document cover 12.

In step 98 the left corners of the document cover 12 are then pressed onto the glass window 36, working outward to each of the respective left-side corners from the central portion 26 of the MSRP Sheet 14, which is secured beneath the document cover 12.

Then in step 100 the exposed surfaces of the right side of the document cover 12 are secured to the glass window 36 by holding the right side of the document cover 12 off the glass window 36, and moving from the midpoint 22 toward right edge of the document cover 12 while pressing downward with the squeegee.

Then in step 102 the corners of the right edges of the document cover 12 are pressed onto the glass window 36, working from a central portion 30 of the Addendum Sheet 16, which is secured beneath the document cover, outward to each of the respective corners. The process ends in step 104.

In some embodiments, the MSRP Sheet 14 and the Addendum Sheet 16 may be formed of paper, plastic, paper coated with plastic, or paper covered with plastic. As an illustration, but not a limitation regarding materials utilized to form the apparatus, the document cover 10 is illustrated by a plastic sheet provided by a 3 mil thick sheet of PVC film, covered with a water based adhesive that can be removed with little or no residue for up to 4 years or longer. The document cover 10 preferably has a matte finish to suppress unwanted reflection.

The document cover 12 as illustrated, but not limited to, preferably measures approximately twenty-one and one-quarter inches by eleven and one-quarter inches, with either rounded or square corners. Other types of documents may also be protected for display on surfaces, including for other industries other than automotive retail sales.

The present invention has several advantages over prior art MSRP Sheet and Addendum Sheet displays. The document display of the present invention provides a clear protective cover for the MSRP Sheet and the Addendum Sheet so that they may be applied to glass surfaces of motor vehicles. This document display easily peals away from the glass surface requiring minimal clean up if any at all. The document display may be run through a car wash, washed multiple times, and be exposed to all types of weather, and still remain on the glass surface protecting MSRP and Addendum Sheets. The document display also preferably inhibits UV light damage to the documents.

The present embodiment overcomes a common objection to affix the documents to the interior side of glass that has window tint applied. In such circumstances, window tint itself is an applied film to the surface of the glass. To affix the document to the inside of the glass to protect the document from external exposure would require the document to be affixed to the interior exposure of the window film. Accordingly, the materials utilized and the application process and subsequent removal process applied are relevant to ensure damage does not occur to the tint film. The present embodiment meets the requirements to properly affix the documents to the window without damaging tint film.

Although the preferred embodiment has been described in detail, it should be understood that various changes, substitutions and alterations can be made therein without departing from the spirit and scope of the invention as defined by the appended claims.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim:

1. An apparatus and method of use to simultaneously affix documents for display on a glass surface comprising:
a. a document cover defined by a sheet of plastic material having a tacky surface and an exterior side, which face in opposite directions;
b. providing tamper resistant, weather resistant and fading resistant protections;
c. providing compliance with regulatory requirements of information disclosures;
d. providing durability for continuous use and exposure to friction, weather, direct sunlight and stresses associated with glass surfaces; and,
e. removable after the duration of time which the information disclosure is required.

2. The apparatus in claim 1, further comprising:
a. Surface area dimensions specific to industry requirements for information disclosures; and,
b. Sectional areas confined within the total surface area which can have multiple documents individually applied to the tacky surface of the document cover, at different times, while maintaining the integrity of the document cover and the utility of the document cover when applied to a glass surface;

3. The apparatus in claim 1, further comprising:
a. Embedded circuitry components capable of visual, optical, radio frequency, magnetic or chemical response to external stimuli or observation;
b. Stimuli response suitable for use in proximity determination, access control, inventory control, time duration or visual cues;
c. Database networking functionality; and,
d. Version control with archiving functionality.

4. The apparatus in claim 1, further comprising plastic material with properties suitable for accepting direct application of ink.

5. A method for providing a document display of an MSRP Sheet, including but not limited to the standard industry description “Monroney” sticker, and/or an Addendum Sheet on a glass surface of a motor vehicle, the method comprising the steps of:
a. laying the document cover on a substantially flat surface with the exterior side face down and the stick side face up;
b. laying the MSRP Sheet and the Addendum Sheet face-down on the tacky surface of the document cover, with a border space provided by the document cover extending fully around each of the MSRP Sheet, and/or the Addendum Sheet;
c. pressing the MSRP Sheet and the Addendum Sheet onto the tacky side of the document cover to adhesively secure the MSRP Sheet and the Addendum Sheet to the document cover, wherein a squeegee is worked from the inside out for each respective one of the MSRP Sheet and the Addendum Sheet;
d. placing the document cover onto an exterior or interior glass surface, with the MSRP Sheet and the Addendum Sheet secured thereto and aligned for display; and,
e. and then, pressing the border space and the center space of the document cover against the glass surface to secure the document cover to the glass surface, working from the inside-out.
